(19) United States
(12) Patent Application Publication
(10) Pub. No.: US 2004/0251113 A1
(43) Pub. Date: Dec. 16, 2004

(54) Driving mechanism for shaking table

(76) Inventor: Paul Robert Tamlin, Lindsay (CA)

Correspondence Address: BIRCH STEWART KOLASCH & BIRCH, PO BOX 747, FALLS CHURCH, VA, 22040-0747, US

(21) Appl. No.: 10/725,461

(22) Filed: Dec. 3, 2003

(30) Foreign Application Priority Data
Jun. 13, 2003 (CA) 2,432,418

(51) Int. Cl. B65G 25/04

(52) U.S. Cl. 198/750.1

(57) ABSTRACT

A driving mechanism causes particulate material to advance on a reciprocating tray. The driving mechanism is connected to a first bar and causes it to reciprocate. The tray rests on the first bar and it too reciprocates. The first bar is spaced apart from a second bar but is attached to it by a spacer. The second bar is mounted in bearings for rotation. The tray may be mounted on oscillating supports attached to a base which underlies the tray. Each of the supports have joints which interconnect the supports with the tray and the base. A resilient insert is mounted within each joint and opposes the forward movement of the tray and assists the tray to return to its starting position.

### BACKGROUND OF THE INVENTION

This invention relates to an apparatus for causing material to advance on a reciprocating tray. More particularly the invention relates to the components that transmit the drive from the prime mover to an oscillating tray. In addition the invention relates to an oscillating support for the tray as it reciprocates.

In the manufacture of particulate consumables, conveyors are required to move the product from one step in the process to the next. If the consumable is relatively strong such as rice, sugar, salt, it can usually be moved on conventional vibrating trays but if the product is fragile such as potato chips and corn flakes, such trays will cause the product to break into smaller pieces. The smaller the pieces, the less commercially acceptable is the finished product.

### SUMMARY OF THE INVENTION

The apparatus of the present invention includes an oscillating bar and a rotating bar. The rotating bar is mounted in bearings and is adapted to rotate therein. At least one spacer interconnects the bars and maintains the bars in a spaced relationship. Driving means is operatively connected to the oscillating bar and imparts oscillating motion to it. A tray on which particulate material is adapted to advance is operatively connected to the oscillating bar and is caused to reciprocate thereby.

The apparatus may include an oscillating support for maintaining the tray spaced apart from a base. The support has a first joint for joining the support to the tray and a second joint for joining the support to the base. A stem runs between the two joints. The joints each have a shank connected to the tray and a socket connected to the stem. The shank is received in the socket and pivots forward when the tray advances and pivots backward when the tray returns to the starting point. Resilient means opposes forward pivotal movement of the shank and urges it to pivot backward.

### DESCRIPTION OF THE DRAWINGS

The apparatus of the invention is described with reference to the accompanying drawings in which:

FIG. 1 is a perspective view of the components of a driving apparatus for the tray;

FIG. 2 is an elevation of the components illustrated in FIG. 1;

FIG. 3 is a perspective view, in enlarged scale, of alternate components of the driving apparatus;

FIG. 4 is a perspective view, in smaller scale than that of the preceding Figures, of the driving apparatus illustrated in FIGS. 1 and 2 together with a tray which is reciprocated by the driving apparatus;

FIG. 5 is an elevation of the tray;

FIG. 6 is an end view of the tray;

FIGS. 7 to 12 are enlarged fragmentary end views of the components of the first embodiment of the driving apparatus as the drive shaft rotates;

FIG. 12A is a graph which shows the relationship between the rate of acceleration and deceleration of the tray throughout its forward and return strokes.

FIG. 13 is a perspective view of the components that transmit the driving motion from the driving apparatus to a number of trays;

FIG. 14 is an elevation of a tray and a portion of the driving mechanism illustrated in FIG. 13;

FIG. 15 is an elevation of the forward portion of a tray and alternate components that activate a tray;

FIG. 16 is a perspective view of a of a tray together with a number of oscillating supports;

FIG. 17 is a perspective view of the tray of FIG. 16 from the side opposite that illustrated in FIG. 16;

FIG. 18 is an elevation of a side of a second embodiment of the oscillating support for the tray of FIGS. 16 and 17; and

FIG. 19 is an elevation of the front of the oscillating support of FIG. 18.

Like reference characters refer to like parts throughout the description of the drawings.

### DESCRIPTION OF THE PREFERRED EMBODIMENTS

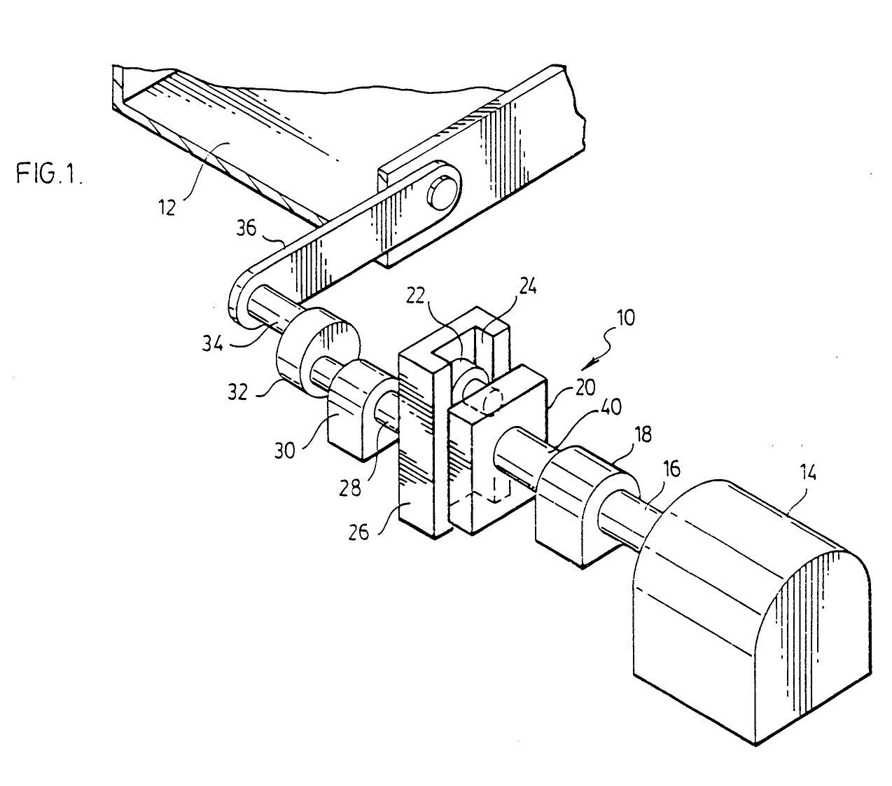

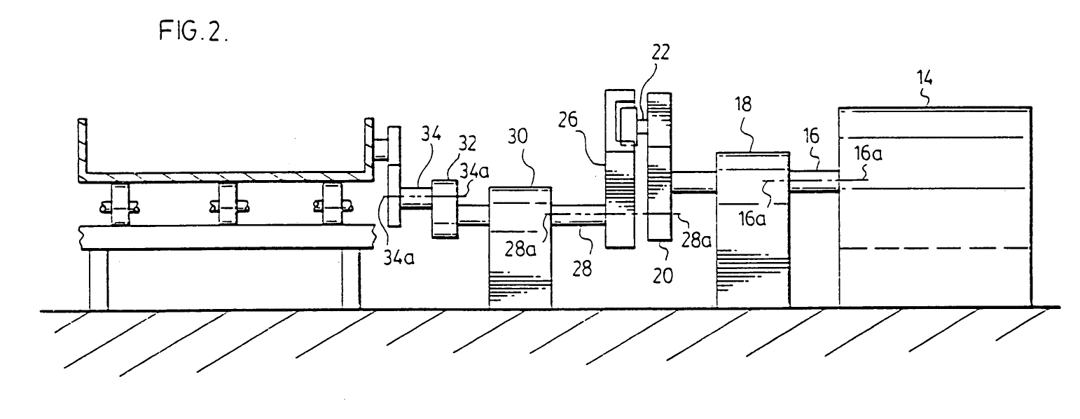

With reference to FIGS. 1 and 2, a driving apparatus, generally 10, is shown in conjunction with a tray 12. The driving apparatus includes a motor 14 which rotates a drive shaft 16. The shaft is mounted in bearings in housing 18 and is connected to a rotating driving block or member 20.

A cam 22 is mounted in bearings on the driving block and is positioned eccentrically with respect to the axis of rotation 16a-16a of the drive shaft. The cam is accommodated in a vertically extending slot 24 formed in a driven block or follower 26.

The follower is affixed to a connecting rod 28. The connecting rod is mounted in bearings in housing 30 and rotates about an axis of rotation 28a-28a. That axis is offset from the axis of rotation 16a-16a of the drive shaft but is parallel to it.

A crank 32 is affixed to the connecting rod 28. A wrist pin 34 is affixed to the crank and is mounted in bearings in an arm 36. The arm is pivotally connected to tray 12.

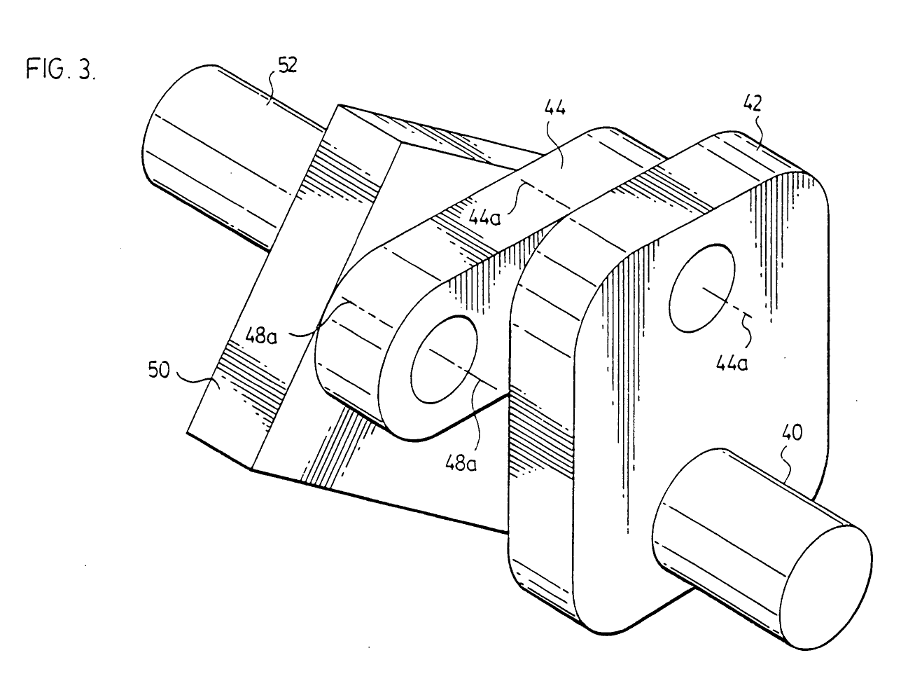

With reference to FIG. 3, a drive shaft 40 is affixed to a rotating driving block or member 42. A link 44 is rotatably mounted in bearings to the block to rotate about axis 44a-44a. The link is also rotatably mounted in bearings to a driven block or member 50 to rotate about an axis 48a-48a. A connecting rod 52 is affixed to the follower.

The axis of rotation 44a-44a of the link is offset from the axis of rotation of drive shaft 40 and the axis of rotation of the connecting rod 52 is also offset from the axis of rotation of the drive shaft.

The mechanism illustrated in FIG. 3 may be substituted for the drive shaft 16, block and follower 20 and 26 and the connecting rod 28 of FIGS. 1 and 2. Thus, link 44 of FIG. 3 substitutes for cam 22 of FIGS. 1 and 2.

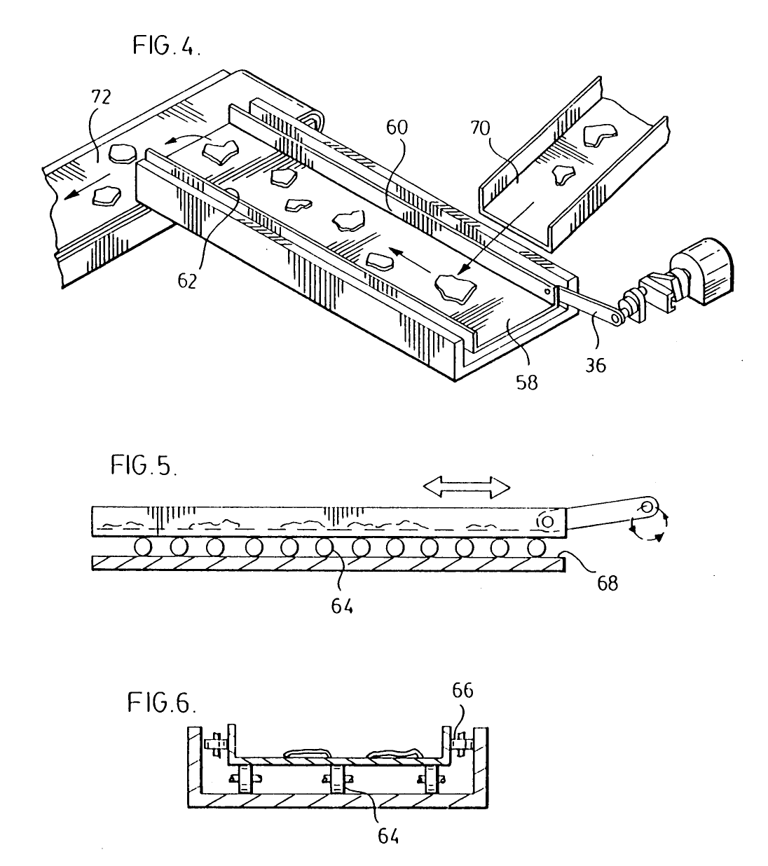

With reference to FIGS. 4 to 6, the tray has a lower wall 58 and side walls 60, 62. Arm 36 is pivotally connected to side wall 60. The lower wall rests on rollers 64 and the side walls contact side rollers 66 to ensure that the tray remains centred within a stationary bed 68 as it reciprocates.

A first conveyor belt 70 carries particulate material to the tray and deposits it on the lower wall and a second conveyor belt 72 carries material which discharges from the tray.

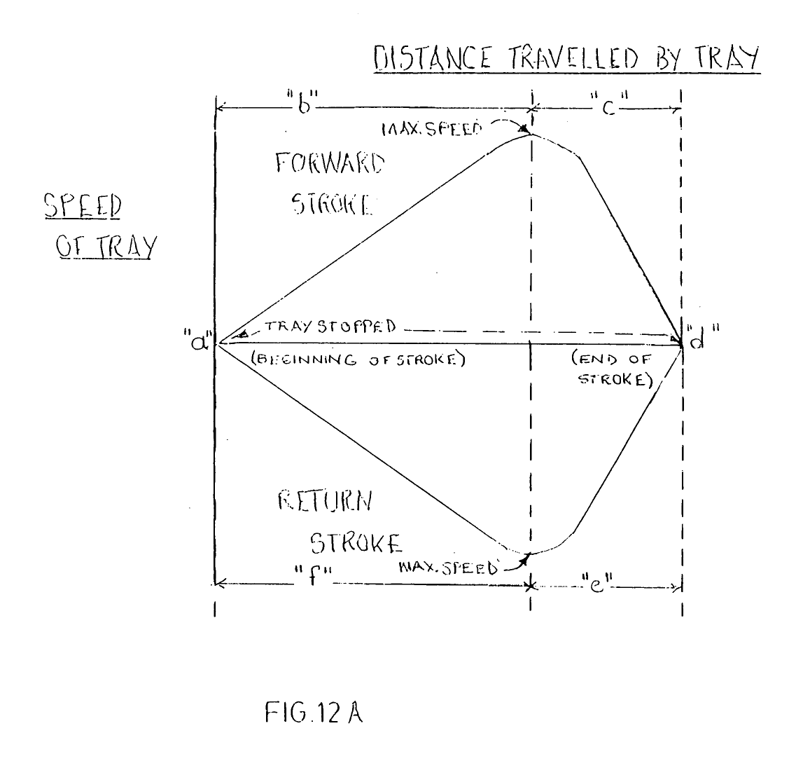

The position of the components of the first embodiment of the driving mechanism as the connecting rod rotates incrementally is illustrated in FIGS. 7 to 12. In FIG. 7 to 11, the shaft rotates in increments of 45 degrees and in FIG. 12, in an increment of 90 degrees from the previous Figure.

With reference first to FIG. 7, the driving block 20 is shown in the 2:00 o'clock position with respect to drive shaft 16 and the cam 22, being connected to the driving block is likewise in the 2:00 o'clock position. The wrist pin 34 rotates about the connecting rod 28 and is shown in the 4:00 o'clock position.

It will be noted in FIG. 7 that the axes of the drive shaft 16, the connecting rod 28, and the wrist pin 34 are all offset from each other. It should also be noted that the drive shaft and connecting rod rotate about their own axes but the wrist pin does not. The pin is affixed to the crank and does not rotate about its axis. It does however rotate about the axis of the connecting rod.

In FIG. 8, the drive shaft 16 has rotated clockwise 45 degrees from the position illustrated in FIG. 7 and the driving block 20 has likewise rotated 45 degrees. The cam has rolled toward the left in the slot 24 of follower 26 from the position illustrated in the previous Figure and the wrist pin 34 has rotated about 22 degrees from the position illustrated in FIG. 7.

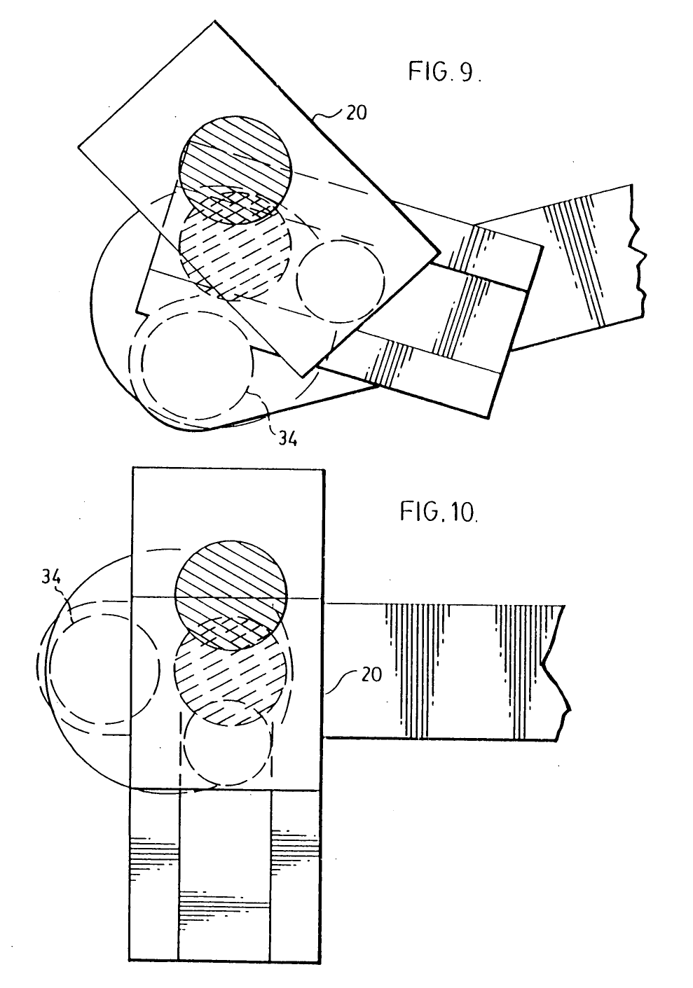

In FIG. 9, driving block 20 has rotated a further 45 degrees and is now in the 4:00 o'clock position. The wrist pin 34 has rotated about 30 degrees from the position illustrated in the previous Figure and is now in the 7:00 o'clock position.

In FIG. 10 driving block 20 is now in the 6:00 o'clock position but wrist pin 34 has rotated 90 degrees from the position illustrated in the previous Figure. Thus a rotation of 45 degrees of the drive shaft has caused a 90 degree rotation of the wrist pin.

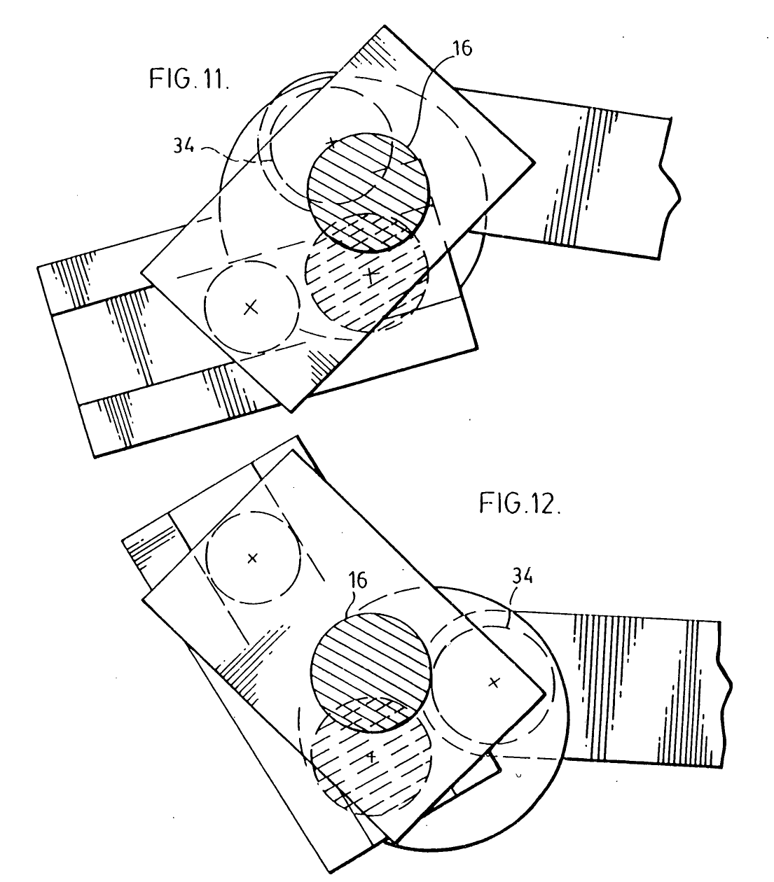

In FIG. 11, drive shaft 16 has again rotated about 45 degrees and caused a 90 degree rotation of wrist pin 34 but in FIG. 12 the reverse has occurred. Drive shaft 16 has rotated 90 degrees from the position illustrated in the previous Figure but wrist pin 34 has rotated only about 45 degrees. As the drive shaft rotates a further 90 degrees from the position illustrated in FIG. 12 to the position illustrated in FIG. 7, the wrist pin rotates only about 45 degrees.

Thus rotation of the drive shaft at a unvarying rate causes a varying rate of rotation of the wrist pin. At times the wrist pin rotates more slowly and at other times it rotates more quickly. Such uneven movement of the wrist pin causes the tray to move in a similar manner and such movement causes particles on the tray to advance when the tray is moving slowly forward and to remain stationary when it is jerked backward.

The operation of the drive mechanism may be summarized as follows. As the drive shaft rotates, so too does the cam. The cam also rolls backwards and forward in the slot. Such motion causes the follower to rotate but the rate of rotation of the follower is irregular because of the offset between the axes of the drive and connecting rods. This irregular movement causes a like movement in the wrist pin.

The irregularity in the movement of the wrist pin can be altered by adjustment in the spacing between the axes of the drive and connecting rods and the spacing between the axes of the output and wrist pins. Thus if the movement is so violent or jerky that the particles on the tray are damaged, the spacing can be altered to reduce the jerkiness or violence.

The wrist pin thus rotates relatively slowly in one direction then rapidly in the opposite direction and such movement causes the tray to reciprocate rapidly in one direction and slowly in the opposite. Such movement will cause particulate material on the tray to move down the tray with little damage to the material.

The drive mechanism causes the tray to move as follows: on the forward stroke of the tray, the tray advances from a starting point to an end point. At the end point the tray is momentarily stationary before it returns to the starting point on its return stroke. The tray, while advancing, first accelerates then decelerates to the end point. The rate of acceleration is less than the rate of deceleration. In other words the tray accelerates more slowly than it decelerates on the forward stroke. On the return stroke, exactly the opposite occurs. The rate of acceleration is more than the rate of deceleration. Thus the tray accelerates more rapidly than it decelerates.

Expressed in another way and with reference to FIG. 12A, the driving apparatus causes the tray to advance on its forward stroke from starting point “a” through a first distance “b” in which the tray accelerates followed by a second distance “c” in which the tray decelerates to an end point “d” where the tray is momentarily stationary. On the return stroke, the tray accelerates through a third distance “e” followed by a fourth distance “f” in which the tray decelerates to starting point “a”. The first distance “b” is longer than the second distance “c”. Preferably the first distance is about twice the second distance. The third distance “e” is shorter than the fourth distance “f”. Preferably, the third distance is about one half of the fourth distance.

As previously indicated, these distances and the rates of acceleration and deceleration can be adjusted by adjustment in the spacing between the axes of the drive and connecting rods and the spacing between the axes of the output and wrist pin.

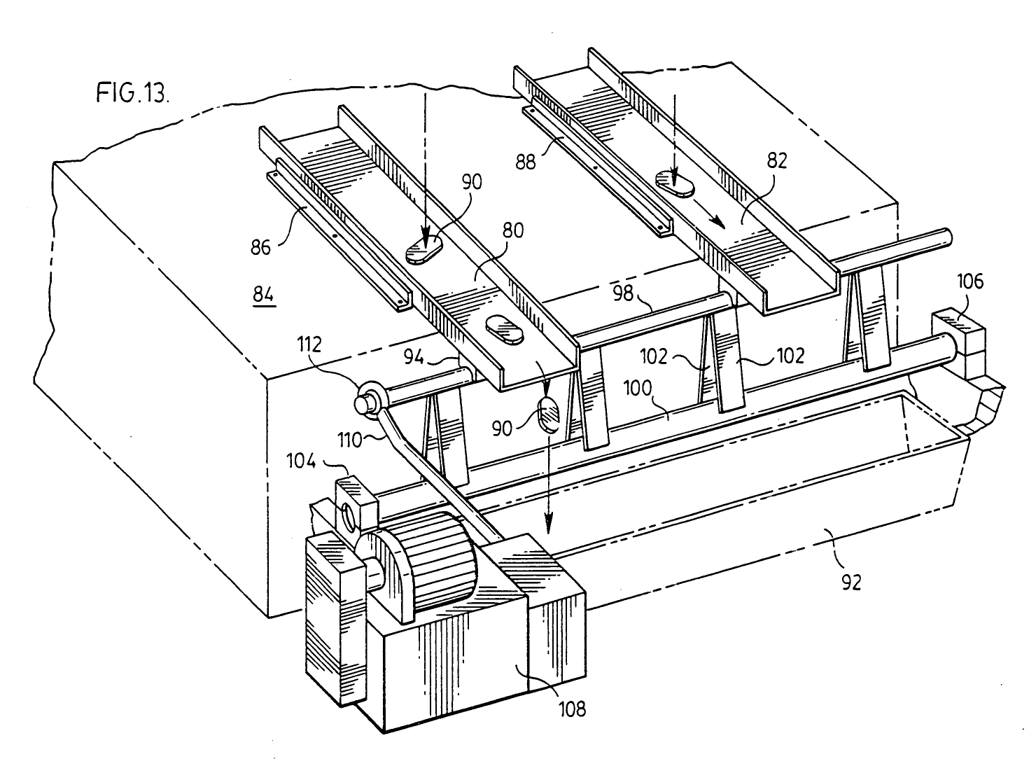

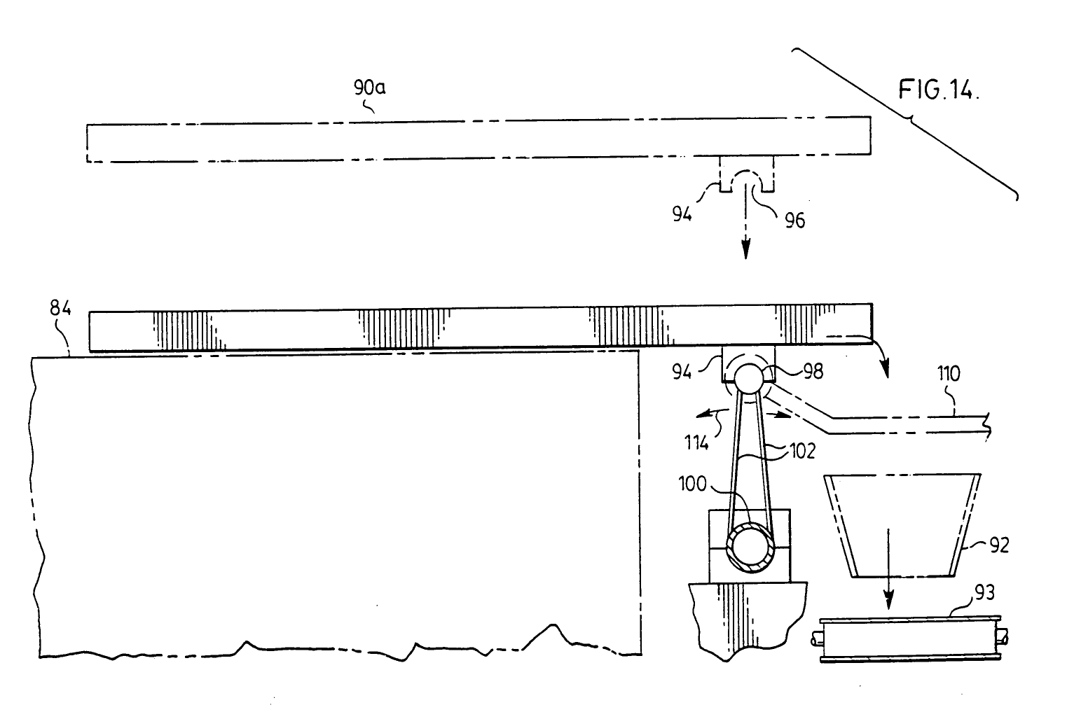

With reference to FIGS. 13 and 14, trays 80, 82 rest on the upper wall of a bed 84 and slide forward and backward on the bed. Guide rails 86, 88 and like rails on the opposite sides of the trays prevent the trays from moving laterally. Particulate material such as slugs or blanks 90 drop onto the trays and are deposited in a bin 92. The material discharges from the bin into a storage container 93.

A drive block 94 is mounted to the lower wall of each tray. The block has a concave lower wall 96 of the same curvature as the outer wall of an oscillating bar 98 which extends beneath the tray. The bar is accommodated in the concave space of the block and gravity ensures that the bar remains in the space as the bar oscillates. The length of the oscillating bar can be varied according to the number of trays that are to be attached to it.

A second rotating bar 100 is located beneath the oscillating bar. A number of spacers 102 interconnect the two bars and maintain them in a spaced parallel relationship. The rotating bar 100 is mounted in bearings 104, 106 and is free to rotate back and forth in the bearings.

As illustrated in FIG. 14, the drive block of the tray merely rests on the oscillating bar. Otherwise it is not connected to the bar or to the bed. Should it be necessary to move the tray along the bed, the tray is simply lifted as at 90a, moved along the bar and placed between a pair of guide rails further along the bed. The tray may also be removed from the bar altogether without disconnecting it from the bar or the bed.

The apparatus 108 for producing reciprocation has the same components as the apparatus illustrated in FIGS. 1 and 2. The apparatus has a coupling or arm 110 similar to arm 36 illustrated in those Figures. An eyelet 112 is attached to the forward end of the coupling and receives the end of the oscillating bar. The bar is thus attached to the coupling and is caused to reciprocate by it but is free to pivot in the eyelet.

In operation, coupling 110 causes bar 98 to oscillate in the direction of arrows 114 in FIG. 14. That bar is supported by the rotating bar 100 which rotates first clockwise then counter-clockwise in the bearings.

Considerable play between the coupling and the oscillating bar is possible without detrimentally affecting the shaking operation. For example, the angle between the longitudinal axes of the coupling and the oscillating bar need not be 90 degrees but may be somewhat more or less than that. Where more deviation of the angle is required, a conventional spherical tie rod can be used to join the two parts.

Thus, careful positioning of the components of the bars and reciprocating mechanism 108 is not necessary for the mechanism to function. Considerable latitude is possible in the choice of location of the components. As a result less time is necessary to position the components than would be the case if their positions relative to each other had to be carefully adjusted.

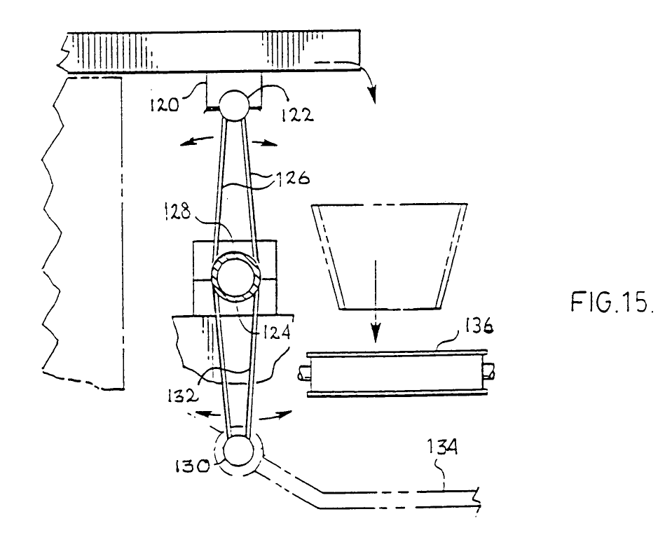

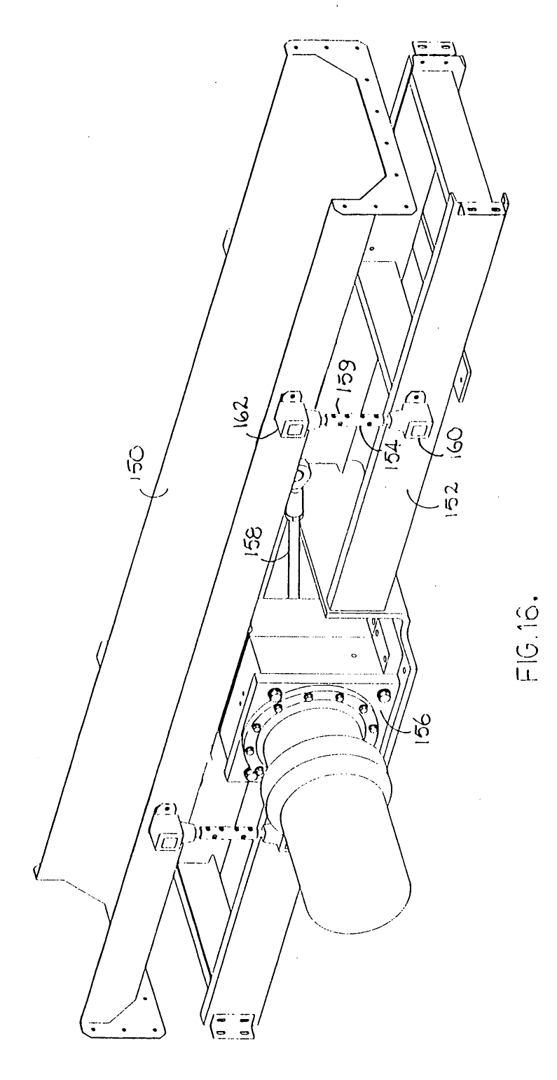

With reference to FIG. 15, drive block 120, similar to block 94 in FIG. 14, rests on oscillating bar 122 and a second rotating bar 124 is located beneath the oscillating bar. Spacers 126 interconnect the two bars in the same way as spacers 102 connect the two bars illustrated in FIG. 14. The rotating bar is mounted in bearings 128.

A third oscillating bar 130 is located beneath the rotating bar and spacers 132 interconnect it to the rotating bar. A coupling or arm 134 similar to arm 110 in FIG. 14 has an eyelet or ring at its forward end. An end of the third bar is received in the eyelet and the coupling thus causes the third bar to oscillate.

In operation, the coupling causes the third bar to oscillate and that oscillating is transmitted to the rotating bar which rotates in the bearings. Since the latter bar is connected to the upper oscillating bar, it oscillates backward and forward at varying speeds and causes the particulate material in the tray to advance toward its forward edge and to fall into bin 136.

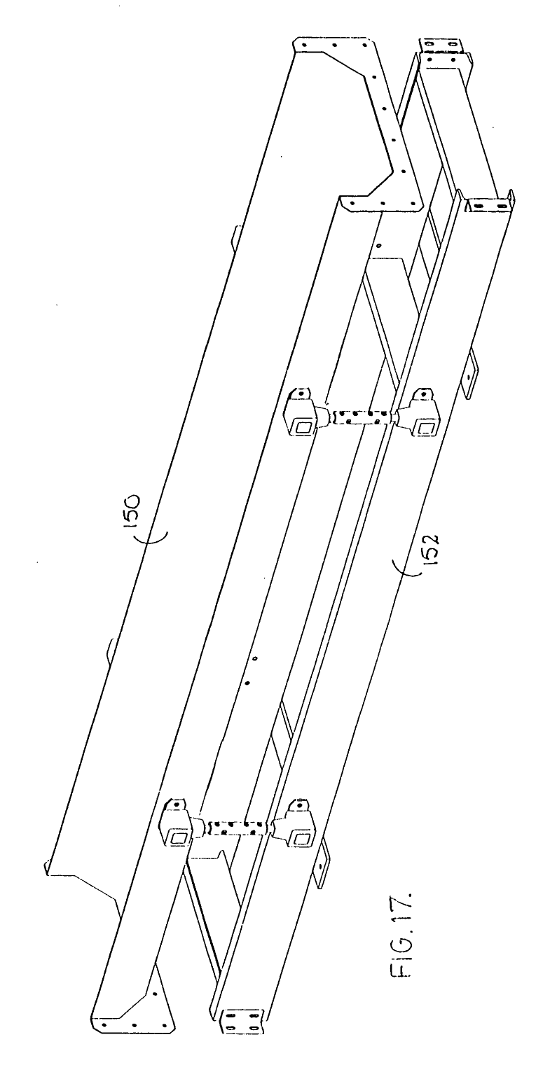

With reference to FIGS. 16 and 17, tray 150 is spaced apart from a stationary base 152 by a number of oscillating supports 154 spaced along the length of the tray. The tray is connected to a driving mechanism 156 by arm 158. The driving mechanism is the same as that described previously and illustrated in FIGS. 1 and 2.

The oscillating supports include a stem 159 and lower and upper joints, generally 160, 162 at opposite ends of the stem. The stems are in the form of tie rods which are threadably attached to the joints. The distance between the sockets can be adjusted by rotation of the tie rods in the usual manner in order to raise and lower the tray.

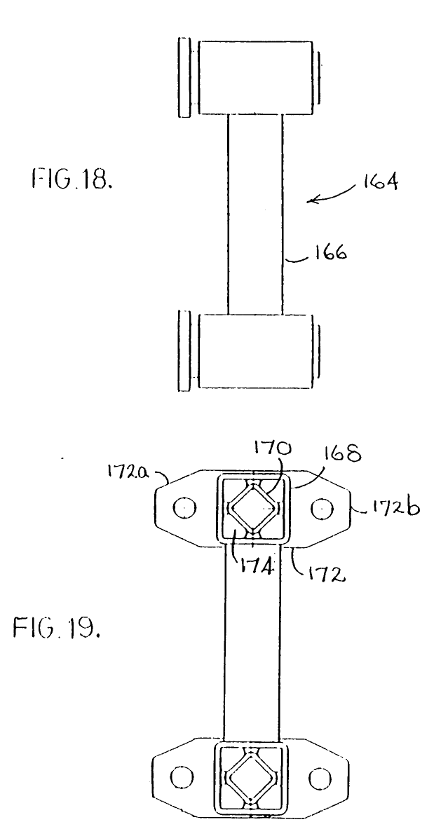

The oscillating support of FIGS. 18 and 19, generally 164, is the same as that illustrated in FIGS. 16 and 17 except that stem 166 is not adjustable so that the spacing between the two joints is fixed. Since the support of FIGS. 18 and 19 is illustrated in greater detail than the ones of FIGS. 16 and 17, it will be described in detail.

Each joint of oscillating support 164 includes a socket 168 having a hollow square outer wall which is open at the front and back. Within the socket is an inflexible shank or rod 170 having a square cross-section. The shank extends backwardly to a plate 172 to which it is attached. The plate has outer tabs 172a,b having apertures for bolts so that the plate may be bolted to the base in the case of the lower joint and to the tray in the case of the upper joint.

The shank is oriented within the socket such that there is a space between its outer walls and the corners of the socket. Within each such space is an insert 174 formed of flexible, resilient material such as rubber.

The socket is held in position about the shank by the inserts, otherwise it is not connected to the shank. The sockets are interconnected by stem 166 but there is no connection between the stem and the shank.

The oscillating support thus described is known and is available from Rosta Inc. of Uxbridge, Ontario, Canada under the name “Rocket Suspension—Type AS-P”.

In operation, the driving mechanism 156 causes the tray to reciprocate backward and forward. As the tray moves forward so too does the shank 170 in the upper socket of each support. As the shank moves it will bear against inserts 174 and urge the upper sockets forward. Such forward motion will cause the sockets at both ends of the supports to rotate slightly with respect to the shanks. Such rotation will cause the inserts to deform resiliently. In the backward stroke of the tray, the inserts will return to their undeformed state The inserts will accordingly resist the forward movement of the tray and encourage the backward movement.

The oscillating supports thus described are particularly useful for supporting a relatively long tray. The power required to cause such a tray to reciprocate is considerably less than, for example, a tray of the same length supported on a table such as that illustrated in FIG. 13. The reason is that the resilient inserts encourage the oscillating supports to return to the starting position on the return stroke of each reciprocation as indicated above.

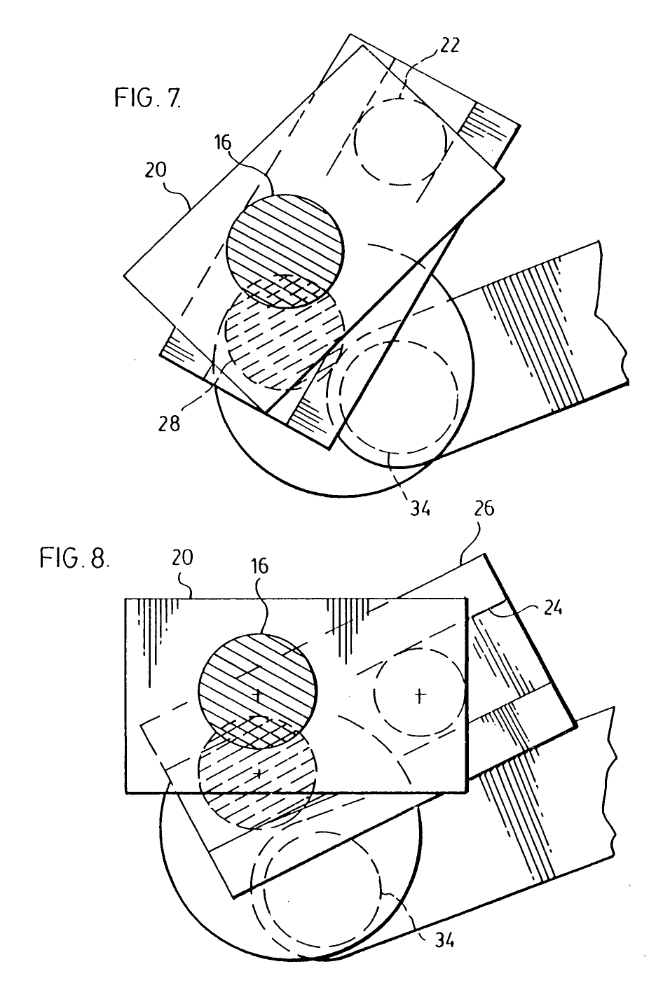

A conventional driving apparatus is designed to direct most of its available power to the forward stroke of the tray and relatively little to the return stroke. As the length of the tray lengthens progressively more power is required to drive the tray on its return stroke. The oscillating supports thus described augment the power of the driving mechanism on its return stroke. There is no such augmentation of power in the apparatus illustrated in FIG. 13. Likewise the rollers of FIGS. 5 and 6 do not augment the power required by the driving apparatus to return the tray to the starting position after each forward stroke.

For the foregoing reasons, the power requirements of a driving apparatus for a relatively long tray, e.g. 100 feet in length, which is supported by the oscillating supports thus described is significantly less than that of a tray of the same length which is supported on a table as in FIG. 13 or rollers as is illustrated in FIGS. 5 and 6.

For greater efficiency, the stem of the oscillating support should be generally vertical as illustrated in FIGS. 16 and 17. If the support is tilted forward, the driving mechanism must not only move the tray horizontally back and forth but also raise the tray slightly each time it goes backward. That is because if the stem is not vertical, each time the tray moves forward, the tray will tend to dip slightly. While energy from inserts as they return to an undeformed state will assist in raising the tray, friction will diminish some of that energy.

It will be understood of course that modifications can be made in the preferred embodiments illustrated and described herein without departing from the scope and purview of the invention as defined in the appended claims.

I claim:

1. An oscillating support for maintaining a tray spaced apart from a base, said tray reciprocating backward and forward at an uneven rate in order to cause particulate material to advance along said tray, said support having a pair of joints, one of which joining said support to said reciprocating tray and the other of which joining said support to said base, resilient means associated with either one of said joints for opposing the forward movement of said tray and for urging said tray backward.

2. An oscillating support for maintaining a tray spaced apart from a base, said tray advancing forward from a starting point then returning backward to said starting point, the rate of advance being less than the rate of return in order to cause particulate material to advance along said tray, said support having a pair of joints, a first said joint for joining said support to said reciprocating tray and a second said joint joining said support to said base, resilient means associated with either one of said joints for opposing the advance of said tray away from the starting point and for urging said tray to return to the starting point.

3. The oscillating support of claim 1 wherein said resilient means is associated with said first joint.

4. The oscillating support of claim 1 wherein said resilient means is associated with both of said joints.

5. The oscillating support of claim 2 wherein said resilient means is associated with said first joint.

6. The oscillating support of claim 2 wherein said resilient means is associated with both of said joints.

7. In combination, an oscillating support for maintaining a tray spaced apart from a base and a driving apparatus for causing said tray to reciprocate such that said tray advances from a starting point to an end point and then returns to said starting point, said support having a first said joint for joining said support to said reciprocating tray and the second said joint joining said support to said base, said first joint having a shank connected to said tray and a socket connected to said stem, said shank being received in said socket and pivoting forward when said tray advances and pivoting backward when said tray returns to the starting point, resilient means for opposing forward pivotal movement of said shank and for urging backward pivotal movement of said shank.

8. In combination, an oscillating support for maintaining a tray spaced apart from a base and a driving apparatus for causing said tray to reciprocate such that said tray advances from a starting point to an end point and then returns to said starting point, said support having a pair of joints and a stem extending therebetween, a first said joint for joining said support to said reciprocating tray and a second said joint joining said support to said base, said second joint having a shank and a socket, said shank being connected to said base and said socket being connected to said stem, said shank being received in said socket and pivoting forward when said tray advances and pivoting backward when said tray returns to the starting point, resilient means for opposing forward pivotal movement of said shank and for urging backward pivotal movement of the shank.

9. In combination, an oscillating support for maintaining a tray spaced apart from a base and a driving apparatus for causing said tray to reciprocate such that said tray advances from a starting point to an end point and then returns to said starting point said support having a pair of joints, a first said joint for joining said support to said reciprocating tray and a second said joint joining said support to said base, each said joint having a shank and a socket, the shank of the first said joint being connected to said tray and the shank of the second said joint being connected to said base, said sockets of the first and second said joints being interconnected, each said shank being received in a separate said socket and pivoting forward when said tray advances and pivoting backward when said tray returns to the starting point, resilient means for opposing forward pivotal movement of said shank and for urging backward pivotal movement of said shank.

10. The combination as claimed in claim 7 wherein said resilient means is disposed within each said socket and is located between said shank and said socket

11. The combination as claimed in claim 7 wherein said driving apparatus causes said tray to advance on its forward stroke from a starting point through a first distance in which said tray accelerates followed by a second distance in which said tray decelerates to an end point where said tray is momentarily stationary after which said tray returns to said starting point through a third distance in which said tray accelerates followed by a fourth distance in which said tray decelerates to said starting point, said first distance being longer than said second distance and said third distance being shorter than said fourth distance.

12. The combination of claim 11 in which the first distance is approximately twice the second distance and the third distance is approximately one half of the fourth distance.

13. The combination as claimed in claims 7 wherein said driving apparatus causes said tray to advance on its forward stroke from a starting point to an end point and then on its return stroke to return to said starting point, said tray, while advancing, first accelerating then decelerating to said end point where said tray is momentarily stationary, the rate of acceleration being less than the rate of deceleration during the advance, said tray, while returning to said starting point, first accelerating then decelerating, the rate of acceleration exceeding the rate of deceleration during the return.

14. The combination as claimed in claim 7 wherein said driving means apparatus comprises: a cam; a drive shaft rotating about an axis and causing said cam to rotate; a follower having a slot formed therein for receipt of said cam, said cam as it rotates, rolling backward and forward in said slot and imparting rotation to said follower; a connecting rod affixed to said follower and being rotated thereby, said connecting rod rotating about a stationary axis which is parallel to but offset from the axis of the rotation of said drive shaft; a crank rotated by said connecting rod and being adapted to be operatively connected to the shaking tray for imparting reciprocating motion to said tray.

15. The combination of claim 14 wherein said operative connection includes: a coupling rotatably connected to said crank; a bar mounted to oscillate and being connected to said coupling, said shaking tray being adapted to be operatively connected to said bar and to be reciprocated thereby.

16. The combination of claim 15 wherein said operative connection includes: a coupling rotatably connected to said crank; a pair of parallel oscillating and rotating bars; at least one spacer which interconnects said bars and maintains said bars in a spaced relationship, said rotating bar being mounted for rotation and said oscillating bar being pivotally connected to said coupling and being caused to reciprocate thereby, said shaking tray being adapted to be operatively connected to said oscillating bar and to be reciprocated thereby.

17. The combination of claim 16 wherein said operative connection between said oscillating bar and said shaking tray includes: a drive block adapted to be connected to said shaking tray and having a wall seated upon said oscillating bar, said oscillating bar imparting linear movement to said drive block.

18. The combination of claim 14 further including a wrist pin mounted for rotation to said crank, said pin having means for pivotal connection to said shaking tray.

19. The combination of claim 7 wherein said driving apparatus includes a shaft rotating about an axis; a link rotated by said drive shaft about an axis offset from the axis of rotation of said drive shaft; a follower connected to said link for rotation about an axis offset from the axis of rotation of said link; a connecting rod affixed to said follower and being rotated thereby; a crank rotated by said connecting rod and being adapted to be operatively connected to the shaking tray for imparting reciprocating motion to said tray.

20. The combination of claim 19 wherein said operative connection includes: a coupling rotatably connected to said crank; a bar mounted to reciprocate and being connected to said coupling, said shaking tray being adapted to be operatively connected to said bar and to be reciprocated thereby.

21. The combination of claim 20 wherein said operative connection includes: a coupling rotatably connected to said crank; a pair of parallel oscillating and rotating bars; at least once spacer which interconnects said bars and maintains said bars in a spaced relationship, said rotating bar being mounted for rotation and said oscillating bar being pivotally connected to said coupling and being caused to reciprocate thereby, said shaking tray being adapted to be operatively connected to said oscillating bar and to be reciprocated thereby.

22. The combination of claim 21 wherein said operative connection between said oscillating bar and said shaking tray includes: a drive block adapted to be connected to said shaking tray and having a wall seated upon said oscillating bar, said oscillating bar imparting linear movement to said drive block.

23. The combination of claim 22 wherein said connecting rod rotates about a stationary axis which is parallel to but offset from the axis of the rotation of said drive shaft.
